(19) United States
(12) Patent Application Publication
(10) Pub. No.: US 2025/0018489 A1
(43) Pub. Date: Jan. 16, 2025

(54) Brazing Method, Brazed Joint, and Braze

(71) Applicant: ABB Schweiz AG, Baden (CH)

(72) Inventors: Christoph Kenel, Baden (CH); Markus Hoidis, Niederrohrdorf (CH)

(73) Assignee: ABB Schweiz AG, Baden (CH)

(21) Appl. No.: 18/899,793

(22) Filed: Sep. 27, 2024

Related U.S. Application Data
(63) Continuation of application No. PCT/EP2023/057747, filed on Mar. 26, 2023.

(30) Foreign Application Priority Data
Mar. 29, 2022 (EP) 22165255.5

(51) Int. Cl. B23K 1/19; B23K 103/00; B23K 103/12

(52) U.S. Cl. CPC B23K 1/19; B23K 2103/12; B23K 2103/50

(57) ABSTRACT

A brazing method for providing a brazed joint. The method comprises directly brazing an AgC contact to a Cu carrier using an active braze.

### CROSS-REFERENCE TO RELATED APPLICATIONS

The instant application claims priority to International Patent Application No. PCT/EP2023/057747, filed Mar. 26, 2023, and to European Patent Application No. 22165255.5, filed Mar. 29, 2022, each of which is incorporated herein in its entirety by reference.

### FIELD OF THE DISCLOSURE

The present disclosure generally relates to a brazing method, a brazed joint, and a braze.

### BACKGROUND OF THE INVENTION

Currently, when joining silver graphite-based contacts, referred to as AgC contacts hereinbelow, onto Cu carriers, this entails the formation of a Ag layer on the back side of the contact to ensure wetting by a braze. This layer is created by addition of Ag.

More specifically, conventional braze alloys, typically of the Cu—Ag—P family, wet only the metallic part of the contact, but do not form any bond with the contained carbon/graphite. Neither pure silver nor copper (and their binary alloys) wet graphite as there is no chemical reaction. This reduces the bonded area, leaving a joint that has both low strength and high electrical resistance. In practice, this issue is solved by joining a layer, also referred to as a backing layer, of Ag to the contact, e.g. by rolling or plating.

This adds cost due to additional processing steps during contact manufacturing and/or by adding an expensive material.

### BRIEF SUMMARY OF THE INVENTION

The present disclosure describes a method and a braze that allow for joining AgC contacts onto Cu carriers while alleviating at least some disadvantages of the known methods. The disclosure describes a brazing method, a brazed joint, and a braze. The disclosure provides a brazing method for obtaining a brazed joint. The method comprises directly brazing an AgC contact to a Cu carrier using an active braze. An advantage of such a method is that no additional processing steps like addition of a backing layer are required. Thus, manufacturing is simplified and costs are reduced. The method also allows for reducing the environmental footprint.

According to the present disclosure, the AgC contacts are directly brazed onto Cu carriers, e.g., without the production of a wetting backing layer. The present disclosure uses active brazing, which allows, in this specific context, for achieving wetting and bonding to the graphite part of the contact material.

Directly brazing an AgC contact to a Cu carrier, according to the present disclosure, may mean that, except for the braze, no material layers are added between the AgC contact and the Cu carrier. In particular, this precludes backing layers. Moreover, the method according to the present disclosure may entail that no decarburization is performed on the AgC contact material prior to brazing.

### BRIEF DESCRIPTION OF THE SEVERAL VIEWS OF THE DRAWING(S)

FIG. 1 is a schematic of a brazed joint according to the present disclosure.

FIG. 2 is a visual of Ag5C directly brazed with Ag-35.25Cu-1.75Ti onto Cu carrier in accordance with the disclosure.

FIG. 3 is an elemental mapping of an induction brazed joint of Ag5C with Cu using Ag-35.25Cu-1.75Ti in accordance with the present disclosure.

FIG. 4 is a schematic of an AgC contact is joined to a Cu carrier via a backing layer as provided by the prior art.

### DETAILED DESCRIPTION OF THE INVENTION

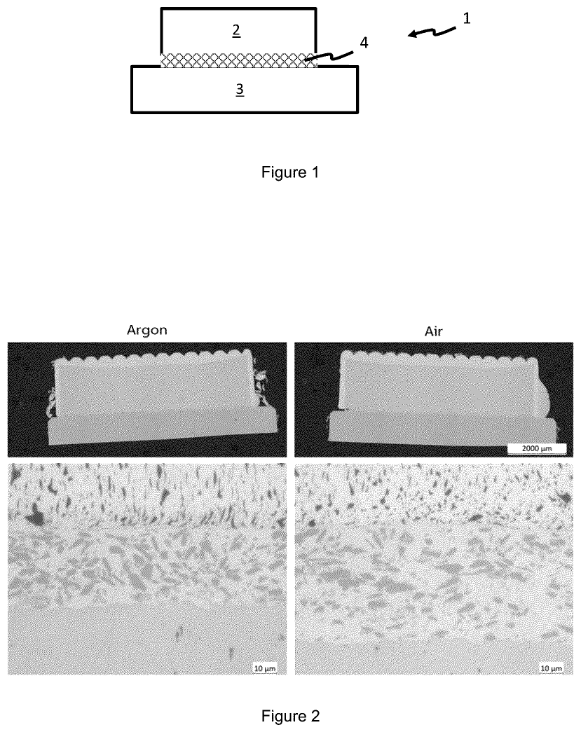

FIG. 1 illustrates schematically a brazed joint 1 comprising an AgC contact 2 brazed directly to a Cu carrier 3 using an active braze 4 according to the present disclosure. The active braze may comprise Ag and/or Cu and an active element selected among Ti, Hf, Zr, Cr, Si, and V. For example, the active braze may comprise an AgCu alloy comprising one or more of said elements, e.g., an AgCuTi or AcCuCr alloy. It is to be understood that additional elements may be comprised in said alloy, particularly additional active elements.

A brazing method according to the present disclosure comprises directly brazing an AgC contact 2 to a Cu carrier 3 using an active braze, for example the active braze described above, e.g., an AgCu alloy comprising an active element, e.g., Ti and/or Cr. Thus a brazed joint 1 according to the present disclosure can be obtained. Brazing may comprise performing a heating with the active brazed interposed between and in contact with each of the Cu carrier and the AgC contact, for example conductive, resistive, or furnace heating. The heating may be performed in air or a protective gas atmosphere. The method may comprise, prior to the brazing, placing the active braze in the form of a foil or a paste between the Cu carrier and the AgC braze or applying the active braze to the Cu carrier or the AgC contact by coating the Cu carrier or AgC contact with the active braze.

FIG. 2 illustrates Ag5C directly brazed with Ag-35.25Cu-1.75Ti onto Cu carriers in argon and air. Both atmospheres lead to a good joint and wet the graphite in Ag5C. In this specific example, Ag5C contacts (5.5×7 mm) were inductively brazed to Cu using an Ag-35.25Cu-1.75Ti (wt. %) braze foil in air. The power level was 8.5 kW and brazing was conducted in 10 s.

The resulting joint shows no pores along the interface and show good bonding to the Ag5C if brazed under Ar or in air. The technique is thus suitable for fast active brazing even in oxidizing environment. This is markedly different from the typical use of active brazes, e.g. to braze ceramics in high vacuum furnaces.

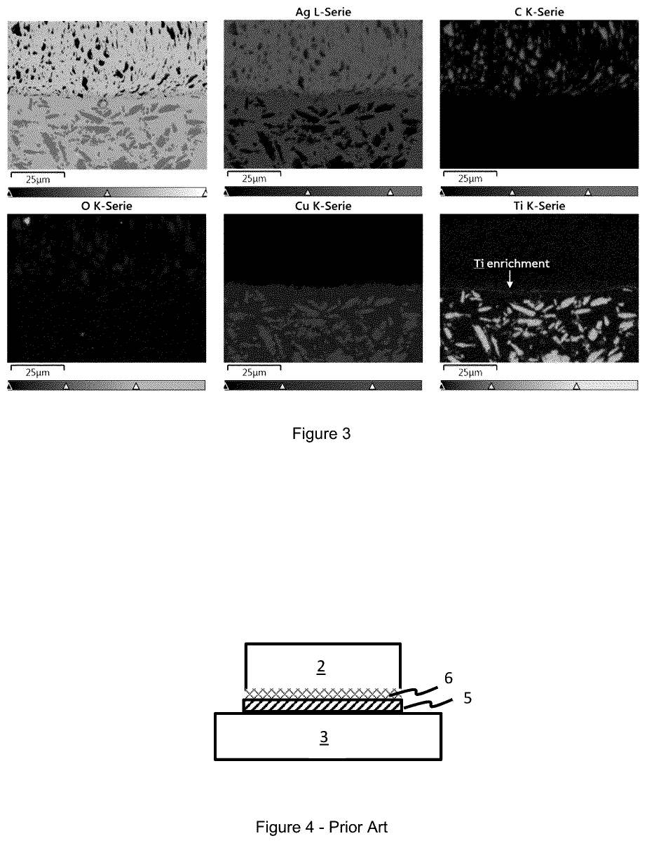

FIG. 3 illustrates an elemental mapping of an induction brazed joint of Ag5C with Cu using Ag-35.25Cu-1.75Ti in air, performed by energy dispersive X-ray spectroscopy in an electron microscope. The mapping demonstrates the extent of Ag5C up to the brazed joint and enrichment of Ti in the interface zone. Remaining Ti in the braze forms Cu—Ti intermetallics throughout the joint. No extensive oxidation is observed within the braze joint.

This demonstrates that indeed a direct brazing of AgC contacts to a Cu carrier using an active braze according to the present disclosure yields high-quality joints.

Further examples for a brazing method of the present disclosure are provided below.
Example 1: AgC inductively brazed in air with Ag-35.25 Cu-1.75 Ti foil (commercially available) in 12 s at a temperature of between 818° C. and 962° C.
Example 2: AgC inductively brazed in argon with Ag-35.25 Cu-1.75 Ti foil (commercially available) in 12 s at a temperature of between 818° C. and 962° C.
Example 3: AgC resistively brazed in air with Ag-35.25 Cu-1.75 Ti paste (commercially available) in 3 s at a temperature between 818° C. and 962° C.
Example 4: AgC inductively brazed with Ag-(20 to 80) Cu—<5 Cr in 12 s at a maximum temperature of less than 962° C.
Example 5: AgC brazed in a vacuum furnace at 800-960° C. in 5-15 minutes with a Cu-(20 to 80) Ag—<2 Cr braze.

As can be seen from the above, the present disclosure provides a new joining concept that directly brazes AgC contacts, e.g., for breakers, onto Cu carriers with an active braze. The active braze may contain Ti, Hf, Zr, Cr, Si and/or V reacting with the typically non-wetting graphite (C) in the AgC contact's material, thereby ensuring wettability and good bonding without the need for a Ag backing layer. This allows for reducing environmental footprint and cost.

The AgC contacts are directly brazed onto Cu carriers, e.g., without the production of a wetting backing layer through de-oxidation or plating on the contacts. The braze according to the present disclosure may contain one or several of Ti, Hf, Zr, Cr, Si and/or V as active elements with the remainder of the braze may be one or several of Ag, Cu and Ni. The braze may be applied in the form of powder, paste or foil. The braze may be placed onto the contacts or carriers in a previous step or applied immediately prior to brazing. Brazing may be performed in protective gas, vacuum or air with heat provided through resistive or inductive heating or in a furnace.

The present disclosure uses active brazing to achieve wetting and bonding to the graphite part of the contact material. Active brazing may be achieved by addition of an active element, or a mixture of several, to the alloy.

As an example, an element may be added to the braze alloy, typically in amounts <5 wt. %, that shows high affinity to carbon/graphite. Suitable elements include Ti, Zr, Hf, Cr, Si and V that all form stable metal carbides. These elements, if added to a braze alloy, react with the exposed carbon from the contact material, thereby locally forming metal carbides. These layers grow on the graphite and into the graphite. Thus they adhere well, but are also wetted by the metallic braze. This allows the metallic braze, typically Cu—Ag-based, to bond to a large area of the contact material.

The approach of the present disclosure is compatible with different ways of brazing. The braze can be applied, as foil, powder or paste. The braze can be placed in-between contact and carrier immediately prior to brazing, or be added to either, contact or carrier, in a previous operation. The latter simplifies later/subsequent processing steps and material handling. Brazing can be performed in protective gas or vacuum to minimize the risk of oxidation, by resistive or inductive heating, or it can be performed by resistive or inductive heating in air. The speed of operation for inductive heating allows reaction between braze and contact before significant oxidation occurs.

FIG. 4 illustrates schematically an AgC contact 2 is joined to a Cu carrier 3 via a backing layer 6 and a braze 5 as provided by the prior art.

While the invention has been illustrated and described in detail in the drawings and foregoing description, such illustration and description are to be considered exemplary and not restrictive. The invention is not limited to the disclosed embodiments. In view of the foregoing description and drawings it will be evident to a person skilled in the art that various modifications may be made within the scope of the invention, as defined by the claims.

In the present disclosure, an AgC contact may be made from any AgC-based contact material, in particular AgC with and without additives. For example, an AgC contact may comprise at least Ag and C, and may optionally comprise one or more additives.

An active element may be an element that has high affinity to carbon, form carbides or dissolve the carbon and thus promote wetting. More details on active elements are provided below.

Brazed contacts of the present disclosure the present disclosure may be used as contacts for switchgear, e.g., contactors or breakers.

The active braze according to the present disclosure may be an alloy comprising one or more active elements, particularly active elements reacting with exposed carbon of the AgC contact, in particular, so as to form metal carbides and/or to dissolve the carbon.

Metal carbide layers may grow on the graphite and into the graphite. Thus, they adhere well and are also wetted by the metallic braze. This allows the metallic braze, particularly Cu—Ag-based active braze, to bond to a large area of the contact material.

According to the present disclosure, the one or more active elements comprise at least one of Ti, Hf, Zr, Cr, Si, and V.

Alternatively or in addition, according to the present disclosure, the one or more active elements may comprise an element having high affinity to carbon/graphite.

High affinity may refer to a negative heat of formation of the corresponding metal carbide. A more negative heat of formation indicates a higher affinity and ability to form the corresponding metal carbide. In particular, elements forming metal carbides with heat of formation more negative than −40 kcal/mol show highest affinity, however, elements with heat of formation as high as −5 kcal/mol may have sufficient affinity.

Alternatively or in addition, according to the present disclosure, the one or more active elements may comprise an element that promotes wetting of the contact by the active braze and/or bonding of the contact by the active braze, in particular, an element that allows for the braze to wet the graphite in the AgC contact.

The one or more active elements may comprise an element that forms a carbide or dissolves the carbon to form a metal carbon solid solution, particularly at brazing temperature. This allows wetting of the braze as the braze alloy now is not in contact to graphite/carbon directly but the reaction product of the active element and carbon/graphite.

Alternatively or in addition, according to the present disclosure, each of the one or more active elements may be added at equal to or less than 5 wt. %. In particular, the active braze may comprise exactly one active element and the active element may be added at equal to or less than 5 wt. %.

According to the present disclosure, the active braze may comprise at least one of Ag and Cu. These braze elements are compatible with AgC and Cu. This does not preclude addition of other compatible braze elements, e.g., Ni.

According to the present disclosure, the active braze may have a solidus of equal to or less than the melting point of Ag. For example, the solidus may be equal to or less than 962° C.

The method of the present disclosure may comprise applying the active braze to the AgC contact and/or the Cu carrier in the form of powder and/or paste and/or foil. In particular, the method of the present disclosure may comprise placing the active braze, e.g., the paste, powder, or foil on the AgC contact or the Cu carrier and then sandwiching the braze between the AgC contact and the Cu carrier. It is to be understood that the applying step is performed prior to the application of heat for brazing.

The method of the present disclosure may comprise, in a processing step separate from the brazing, particularly prior to the brazing, producing a coated AgC contact, coated with the active braze such that the coated AgC contact is suitable for being stored and for being brazed at a later point in time by the application of heat. The coated AgC contact may be used as the AgC contact described throughout the present disclosure.

Alternatively or in addition, the method of the present disclosure may comprise in a processing step separate from, particularly prior to, the brazing, producing a coated Cu carrier coated with the active braze such that the coated Cu carrier is suitable for being stored and for being brazed at a later point in time by the application of heat. The coated Cu carrier may be used as the Cu carrier described throughout the present disclosure.

Using coated Cu carriers or AgC contacts may simplify subsequent processing steps and material handling.

According to the present disclosure, directly brazing the AgC contact to the Cu carrier may comprise performing heating, with the active braze interposed between the Cu carrier and the AgC contact and in contact with each of the Cu carrier and the AgC contact, in particular, wherein the heating comprises inductive heating and/or resistive heating and/or furnace heating.

According to the present disclosure, the brazing may be performed in an oxidizing atmosphere, for example air, or in a protective gas atmosphere, or in a vacuum.

For example, brazing may be performed in protective gas or vacuum to minimize the risk of oxidation, by resistive heating, or it can be performed by inductive heating in air. The speed of operation for inductive or resistive heating allows reaction between braze and contact before significant oxidation occurs. Accordingly, no protective atmosphere is required.

According to the present disclosure, the brazing may be performed over a heating time of equal to or less than 20 s, in particular equal to or less than 15 s, in particular equal to or less than 10 s, in particular equal to or less than 5 s, in particular a time of 3 s.

According to the present disclosure, the brazing may be performed at a temperature of equal to or less than 1000° C. and equal to or more than 500° C., in particular, equal to or less than 1000° C. and equal to or more than 600° C., in particular, equal to or less than 1000° C. and equal to or more than 700° C., in particular, equal to or less than 1000° C. and equal to or more than 800° C. As example, the brazing may be performed at a temperature of equal to or less than 962° C. and equal to or more than 640° C.

An example for the method of the present disclosure comprises inductively brazing in air or in argon using an AgCuTi active braze in the form of a foil, for example by heating at a temperature between 818° C. and 962° C. for 12 s.

Another example for the method of the present disclosure comprises resistively brazing in air using an AgCuTi active braze in the form of a paste, for example by heating at a temperature between 818° C. and 962° C. for 3 s.

Another example for the method of the present disclosure comprises brazing in air using an AgCuCr active braze, for example by heating at a temperature between 818° C. and 962° C. for 3 s.

Another example for the method of the present disclosure comprises brazing with AgCuCr active braze at a maximum temperature of less than 962° C. for 12 s.

Another example for the method of the present disclosure comprises brazing with AgCuCr active braze in a vacuum furnace at 800-960° C. in 5-15 minutes.

The invention also provides an active braze configured to allow for directly brazing AgC contacts to a Cu carrier. In particular, the active braze of the invention may be configured for use in a method according to the present disclosure, particularly described above.

The active braze according to the present disclosure may be an alloy comprising one or more active elements, particularly reacting with exposed carbon of the AgC contact, in particular, so as to form metal carbides and/or to dissolve the carbon.

The one or more active elements may comprise at least one of Ti, Hf, Zr, Cr, Si, and V. Alternatively or in addition, the one or more active elements may comprise an element having high affinity to carbon/graphite. Alternatively or in addition one or more active elements comprise an element that promotes wetting of the contact by the active braze and/or bonding of the contact by the active braze, in particular, an element that allows for the braze to wet the graphite in the AgC contact.

Each of the one or more active elements may be added at equal to or less than 5 wt. %. In particular, the active braze may comprise exactly one active element and the active element may be added at equal to or less than 5 wt. %.

The active braze of the present disclosure may have a solidus of equal to or less than the melting point of Ag, in particular equal to or less than 962° C. Alternatively or in addition, the active braze, in addition to the one or more active elements, may comprise at least one of Ag and Cu.

The invention also provides a brazed joint 1 having an AgC contact directly brazed to a Cu carrier by means of an active braze, particularly an active braze according to the present disclosure, e.g., as described or claimed. The brazed joint may be a brazed joint obtained by carrying out a method according to the present disclosure, particularly a method as described above or claimed.

The features and advantages outlined above in the context of the method similarly apply to the active brazes and the brazed joints described herein.

Further features, examples, and advantages will become apparent from the detailed description making reference to the accompanying drawings.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A brazing method for obtaining a brazed joint, the method comprising directly brazing an AgC contact to a Cu carrier using an active braze.

2. The method of claim 1, wherein the active braze is an alloy comprising one or more active elements, particularly active elements reacting with exposed carbon of the AgC contact, in particular, so as to form metal carbides and/or to dissolve the carbon.

3. The method of claim 2, wherein the one or more active elements comprise at least one of Ti, Hf, Zr, Cr, Si, and V.

4. The method of claim 2, wherein the one or more active elements comprise an element having high affinity to carbon/graphite.

5. The method of claim 2, wherein the one or more active elements comprise an element that promotes wetting of the contact by the active braze and/or bonding of the contact by the active braze, in particular, an element that allows for the braze to wet the graphite in the AgC contact.

6. The method of claim 2, wherein each of the one or more active elements are added at equal to or less than 5 wt. %, in particular, wherein the active braze comprises exactly one active element and the active element is added at equal to or less than 5 wt. %.

7. The method of claim 2, wherein the active braze comprises at least one of Ag and Cu.

8. The method of claim 1, wherein the active braze has a solidus of equal to or less than the melting point of Ag.

9. The method of claim 1, the method further comprising applying the active braze to the AgC contact and/or the Cu carrier in the form of powder and/or paste and/or foil.

10. The method of claim 1, the method further comprising, in a processing step separate from the brazing, producing a coated AgC contact, coated with the active braze such that the coated AgC contact is suitable for being stored and for being brazed at a later point in time by the application of heat, and, in particular, using the coated AgC contact as the AgC contact, and/or in a processing step separate from the brazing, producing a coated Cu carrier coated with the active braze such that the coated Cu carrier is suitable for being stored and for being brazed at a later point in time by the application of heat, and, in particular, using the coated Cu carrier as the Cu carrier.

11. The method of claim 1, wherein directly brazing the AgC contact to the Cu carrier comprises performing heating, with the active braze interposed between the Cu carrier and the AgC contact and in contact with each of the Cu carrier and the AgC contact, in particular, wherein the heating comprises inductive heating and/or resistive heating and/or furnace heating.

12. The method of claim 1, wherein the brazing is performed in an oxidizing atmosphere, for example air, or in a protective gas atmosphere, or in a vacuum, and/or wherein the brazing is performed over a time of equal to or less than 20 s, and/or wherein the brazing is performed at a temperature of equal to or less than 1000° C.

13. The method of claim 1, wherein the active braze is an alloy comprising one or more active elements, particularly reacting with exposed carbon of the AgC contact so as to form metal carbides and/or to dissolve the carbon.

14. The method of claim 13, wherein the one or more active elements comprise at least one of Ti, Hf, Zr, Cr, Si, and V, and/or wherein the one or more active elements comprise an element having high affinity to carbon/graphite.

15. The method of claim 13, wherein one or more active elements comprise an element that promotes wetting of the contact by the active braze and/or bonding of the contact by the active braze, wherein the element allows for the braze to wet the graphite in the AgC contact.

16. The method of claim 13, wherein each of the one or more active elements is added at equal to or less than 5 wt. %, wherein the active braze comprises exactly one active element and the active element is added at equal to or less than 5 wt. %, and/or wherein the active braze has a solidus of equal to or less than the melting point of Ag, equal to or less than 962° C. and/or wherein the active braze, in addition to the one or more active elements, comprises at least one of Ag and Cu.
